(19) United States
(12) Patent Application Publication
(10) Pub. No.: US 2023/0216115 A1
(43) Pub. Date: Jul. 6, 2023

(54) SECONDARY BATTERY

(71) Applicant: MURATA MANUFACTURING CO., LTD., Kyoto (JP)

(72) Inventors: Moriaki OKUNO, Kyoto (JP); Rie WATANABE, Kyoto (JP); Kazuki HONDA, Kyoto (JP)

(21) Appl. No.: 18/120,150

(22) Filed: Mar. 10, 2023

Related U.S. Application Data
(63) Continuation of application No. PCT/JP2021/027129, filed on Jul. 20, 2021.

(30) Foreign Application Priority Data
Sep. 17, 2020 (JP) 2020-156154

(51) Int. Cl. H01M 50/148; H01M 50/109; H01M 50/559; H01M 50/169; H01M 10/0525

(52) U.S. Cl. CPC H01M 50/154; H01M 10/0525; H01M 50/109; H01M 50/169; H01M 50/559

(57) ABSTRACT

A secondary battery includes an outer package member, an electrode terminal, and a battery device. The outer package member has a flat and columnar shape and includes a first bottom part and a second bottom part opposed to each other. The electrode terminal is supported by the first bottom part and is insulated from the first bottom part. The battery device is contained inside the outer package member and includes a first electrode and a second electrode. The first bottom part has a recess around the electrode terminal.

### CROSS REFERENCE TO RELATED APPLICATIONS

The present application is a continuation of PCT/JP2021/027129, filed on Jul. 20, 2021, which claims priority to Japanese patent application no. JP2020-156154, filed on Sep. 17, 2020, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, in a secondary battery of a coin type in which a sealing case and a cap case are crimped to each other with a gasket interposed therebetween, the cap case is provided with one or more notched parts in order to prevent rupture of the secondary battery caused by an increase in internal pressure in a case where a temperature is high. In such a secondary battery, if the internal pressure increases in the case where the temperature is high, softening deformation of the gasket loosens the gasket in the periphery of the one or more notched parts, which releases the internal pressure.

In a secondary battery of a button type in which a cell cup and a cell cover are crimped to each other, the cell cup has a gas through hole to prevent rupture of the secondary battery caused by an increase in internal pressure in a case where a temperature is high. In such a secondary battery, if the internal pressure increases in the case where the temperature is high, the cell cover slides to open the gas through hole, which releases the internal pressure.

### SUMMARY

The present technology relates to a secondary battery.

Although consideration has been given in various ways to improve various characteristics of a secondary battery, safety of the secondary battery still remains insufficient. Accordingly, there is still room for improvement in terms thereof.

It is therefore desirable to provide a secondary battery that is able to achieve superior safety.

A secondary battery according to an embodiment of the present technology includes an outer package member, an electrode terminal, and a battery device. The outer package member has a flat and columnar shape and includes a first bottom part and a second bottom part opposed to each other. The electrode terminal is supported by the first bottom part and is insulated from the first bottom part. The battery device is contained inside the outer package member and includes a first electrode and a second electrode. The first bottom part has a recess around the electrode terminal.

According to the secondary battery of an embodiment of the present technology, the electrode terminal is supported by the first bottom part of the outer package member having the flat and columnar shape, the electrode terminal is insulated from the first bottom part, and the first bottom part has the recess around the electrode terminal. This makes it possible to achieve superior safety.

Note that effects of the present technology are not necessarily limited to those described herein and may include any of a series of suitable effects in relation to the present technology.

### BRIEF DESCRIPTION OF THE FIGURES

FIG. 1 is a perspective view of a configuration of a secondary battery according to an embodiment of the present technology.

FIG. 2 is a sectional view of the configuration of the secondary battery illustrated in FIG. 1.

FIG. 3 is a plan view of a configuration of the secondary battery illustrated in FIG. 2.

FIG. 4 is a sectional view of a configuration of a battery device illustrated in FIG. 2.

FIG. 5 is a sectional view for describing an operation of the secondary battery.

FIG. 6 is a perspective view of a configuration of an outer package can to be used in a process of manufacturing the secondary battery.

FIG. 7 is a plan view of a configuration of a secondary battery of an embodiment.

FIG. 8 is a plan view of a configuration of a secondary battery of an embodiment.

FIG. 9 is a plan view of a configuration of a secondary battery of an embodiment.

FIG. 10 is a sectional view of a configuration of a secondary battery of an embodiment.

FIG. 11 is a sectional view for describing an operation of the secondary battery of an embodiment.

### DETAILED DESCRIPTION

One or more embodiments of the present technology are described below in further detail including with reference to the drawings.

A description is given of a secondary battery according to an embodiment of the present technology.

The secondary battery to be described here is a secondary battery that is commonly referred to by a term such as a coin type or a button type, and has a flat and columnar three-dimensional shape. As will be described later, the secondary battery includes two bottom parts opposed to each other, and a sidewall part coupled to each of the two bottom parts. This secondary battery has a height smaller than an outer diameter. The “outer diameter” is a diameter (a maximum diameter) of each of the two bottom parts. The “height” is a distance (a maximum distance) from one of the bottom parts to another of the bottom parts.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode. This is to suppress precipitation of the electrode reactant on a surface of the negative electrode during charging.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains the battery capacity using insertion and extraction of lithium is a so-called lithium-ion secondary battery. In the lithium-ion secondary battery, lithium is inserted and extracted in an ionic state.

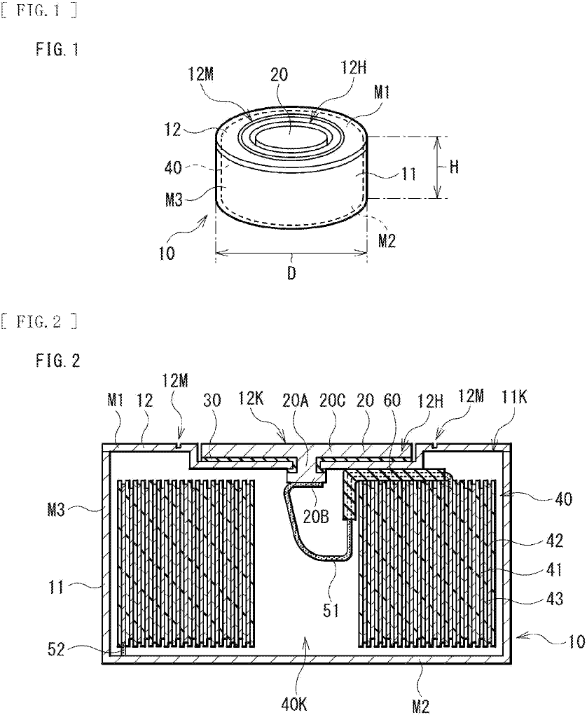

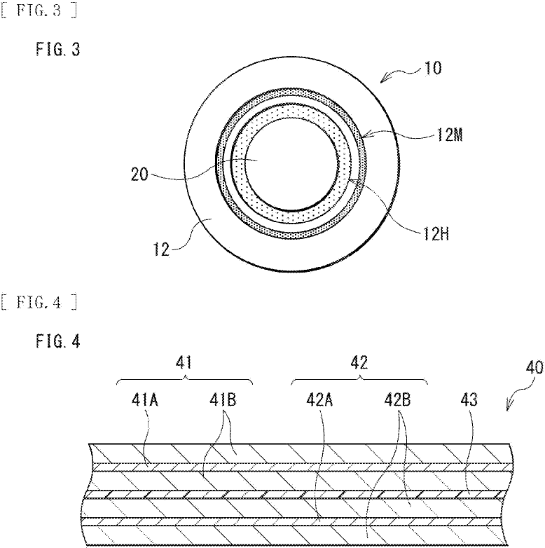

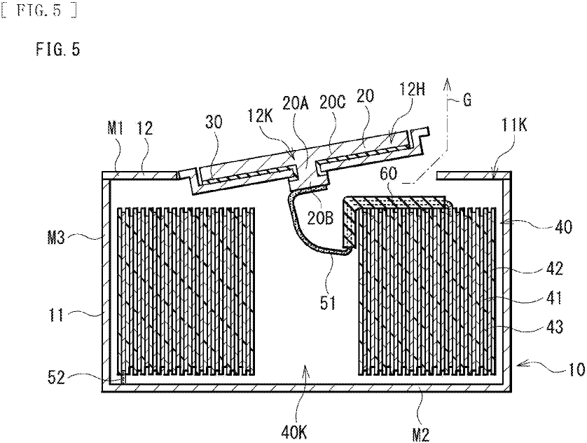

FIG. 1 illustrates a perspective configuration of the secondary battery. FIG. 2 illustrates a sectional configuration of the secondary battery illustrated in FIG. 1. FIG. 3 illustrates a configuration, in a plan view, of the secondary battery illustrated in FIG. 2. FIG. 4 illustrates a sectional configuration of a battery device 40 illustrated in FIG. 2.

For convenience, the following description is given with an upper side of each of FIGS. 1 and 2 assumed as an upper side of the secondary battery, and a lower side of each of FIGS. 1 and 2 assumed as a lower side of the secondary battery.

In FIG. 2, a positive electrode lead 51 and a negative electrode lead 52 are each shaded. FIG. 3 illustrates a state of the secondary battery as viewed from above. In FIG. 3, a bent part 12H is lightly shaded and a cleavage recess 12M is darkly shaded. FIG. 4 illustrates a portion of a section of the battery device 40 in an enlarged manner.

As illustrated in FIG. 1, the secondary battery has an outer diameter D and a height H, and has such a three-dimensional shape that the height H is smaller than the outer diameter D, that is, the flat and columnar three-dimensional shape as described above. Here, the three-dimensional shape of the secondary battery is flat and cylindrical (circular columnar).

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., a dimensional ratio D/H, is greater than 1. Although not particularly limited, an upper limit of the dimensional ratio D/H is preferably less than or equal to 25.

Specifically, as illustrated in FIGS. 1 to 4, the secondary battery includes an outer package can 10, an external terminal 20, and the battery device 40. Here, the secondary battery further includes a gasket 30, the positive electrode lead 51, the negative electrode lead 52, and a sealant 60.

As illustrated in FIGS. 1 to 3, the outer package can 10 is an outer package member having a flat and columnar shape, and has a hollow structure to contain the battery device 40 and other components therein.

Here, the outer package can 10 has a flat and cylindrical three-dimensional shape corresponding to the flat and cylindrical three-dimensional shape of the secondary battery. Accordingly, the outer package can 10 includes an upper bottom part M1 and a lower bottom part M2 opposed to each other, and more specifically, includes a sidewall part M3 coupled to each of the upper bottom part M1 and the lower bottom part M2, together with the upper bottom part M1 and the lower bottom part M2.

The upper bottom part M1 is a first bottom part out of the first bottom part and a second bottom part opposed to each other, and the lower bottom part M2 is the second bottom part. The sidewall part M3 is disposed between the upper bottom part M1 and the lower bottom part M2. The sidewall part M3 thus has an upper end part coupled to the upper bottom part M1, and a lower end part coupled to the lower bottom part M2. As described above, the outer package can 10 is cylindrical. Thus, the upper bottom part M1 and the lower bottom part M2 each have a circular plate shape, and the sidewall part M3 has a cylindrical shape having a convexly curved surface.

The outer package can 10 includes a container part 11 and a cover part 12. The container part 11 is sealed by the cover part 12. Here, the cover part 12 is welded to the container part 11.

The container part 11 is a flat and cylindrical container-shaped member containing the battery device 40 and other components inside. The container part 11 corresponds to the lower bottom part M2 and the sidewall part M3. The container part 11 has a hollow structure with an upper end part open and a lower end part closed, and thus has an opening 11K at the upper end part.

The cover part 12 is a disk-like plate-shaped member that closes the opening 11K of the container part 11. The cover part 12 corresponds to the upper bottom part M1. The cover part 12 has a through hole 12K, and is welded to the container part 11 at the opening 11K. The external terminal 20 is attached to the cover part 12, and the cover part 12 thus supports the external terminal 20.

A thickness (a wall thickness) of the cover part 12 is not particularly limited. The thickness of the cover part 12 is preferably smaller than a thickness of the container part 11, in particular. That is, the thickness of the cover part 12 serving as the upper bottom part M1 is preferably smaller than a thickness of the lower bottom part M2. A reason for this is that this makes physical strength of the cover part 12 (the upper bottom part M1) lower than physical strength of the container part 11 (the lower bottom part M2), and thus allows the cover part 12 to cleave easily through the use of the cleavage recess 12M, which will be described later, upon an increase in internal pressure. It is to be noted that a cause of the increase in the internal pressure is not particularly limited. For example, the increase in the internal pressure is caused in a case where the secondary battery is overcharged, or in a case where the secondary battery is used or stored in a high temperature environment.

In this case, the thickness of the cover part 12 is more preferably smaller than a thickness of the sidewall part M3 in addition. A reason for this is that this makes the physical strength of the cover part 12 (the upper bottom part M1) lower than the physical strength of the container part 11 (the sidewall part M3), and thus allows the cover part 12 to cleave more easily through the use of the cleavage recess 12M upon the increase in the internal pressure.

For example, the thickness of the container part 11 (each of the lower bottom part M2 and the sidewall part M3) is within a range from 80 µm to 200 µm both inclusive, and the thickness of the cover part 12 (the upper bottom part M1) is within a range from 60 µm to 180 µm both inclusive.

Here, the cover part 12 is so bent as to protrude in part toward the inside of the outer package can 10 (the container part 11). The cover part 12 is thus recessed in part. In other words, a portion of the cover part 12 is so bent as to form a step toward a center of the cover part 12. The portion of the cover part 12 thus forms the step. Accordingly, the cover part 12 includes the bent part 12H which is provided by bending the cover part 12 to cause the cover part to protrude in part toward the inside of the container part 11, and the through hole 12K is provided in the bent part 12H. A reason why the bent part 12H is provided is that the cover part 12 is pressed easily toward the outside upon an increase in the internal pressure because a portion of the cover part 12 provided with the bent part 12H protrudes toward the inside of the outer package can 10 as described above. Another reason is that the vicinity of the level distance (a portion on an inner side and on an outer side of the level distance) distorts, allowing the cover part 12 to be deformed easily through the use of the bent part 12H. This allows the cover part 12 to cleave more easily through the use of the cleavage recess 12M.

The cover part 12 is bent once to have the bent part 12H. The cover part 12 including such a bent part 12H thus has one step. However, the cover part 12 may be bent twice or more to have two or more steps.

In particular, the cover part 12 has the cleavage recess 12M around the external terminal 20. The cleavage recess 12M is a recess for allowing, upon an increase of a pressure inside the secondary battery, i.e., the internal pressure of the secondary battery, the cover part 12 to cleave in part or entirely in response to the increase in the internal pressure. The thickness of the cover part 12 at a location where the cleavage recess 12M is provided is thus smaller than the thickness of the cover part 12 at a location where the cleavage recess 12M is provided. Here, the cleavage recess 12M is provided on the outer side (an upper surface) of the cover part 12.

Here, the cleavage recess 12M is provided entirely around the external terminal 20. That is, the cleavage recess 12M is provided continuously around the external terminal 20 without being absent in any point, and therefore continuously surrounds the external terminal 20. A reason for this is that this allows the cover part 12 to cleave easily through the use of the cleavage recess 12M upon an increase in the internal pressure.

A shape of the cleavage recess 12M in a plan view is not particularly limited. Here, because the bent part 12H and the external terminal 20 each have a substantially circular shape in a plan view, the shape of the cleavage recess 12M in a plan view is a substantially circular ring shape. That is, the cover part 12 has the cleavage recess 12M having a ring shape. The bent part 12H, the cleavage recess 12M, and the external terminal 20 are provided concentrically. However, the shape, in a plan view, of the cleavage recess 12M that is the ring shape is not limited to a circular shape, and may be a polygonal shape, or a shape combining a circular shape and a polygonal shape.

A placement location of the cleavage recess 12M is not particularly limited. In a case where the cover part 12 includes the bent part 12H, in particular, the cleavage recess 12M is preferably provided at a portion, of the cover part 12, not including the bent part 12H, that is, on an outer side or an inner side relative to the bent part 12H. A reason for this is that, when an increase in the internal pressure generates force (pressing force) pressing the cover part 12 toward the outer side, this allows a difference in the pressing force to be easily produced between the outer side and the inner side of the bent part 12H. The cover part 12 is thus distorted easily due to the difference in the pressing force, allowing the cover part 12 to cleave more easily through the use of the cleavage recess 12M.

In this case, the cleavage recess 12M is preferably provided at a position that is as close as possible to the bent part 12H. A reason for this is that this allows the above-described distortion to occur more easily, and therefore allows the cover part 12 to cleave further more easily through the use of the cleavage recess 12M.

Note that the number of the cleavage recesses 12M is not particularly limited. Here, the cover part 12 has one cleavage recess 12M. It goes without saying that a width and a depth of the cleavage recess 12M are each not particularly limited and may each be chosen as desired. For example, the width of the cleavage recess 12M is within a range from 0.01 mm to 1 mm both inclusive, and the thickness of the cover part 12 at the location where such a cleavage recess 12M is provided is within a range from 0.01 mm to 0.15 mm both inclusive. A reason for this is that this allows the cover part 12 to cleave easily through the use of the cleavage recess 12M.

As described above, the outer package can 10 is a can (a so-called welded can) in which two members (the container part 11 and the cover part 12) are welded to each other. As a result, the outer package can 10 after undergoing welding is physically a single member as a whole, and is thus in a state of being not separable into the two members (the container part 11 and the cover part 12) afterward.

The outer package can 10 as a welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 is not in a state in which two or more members are assembled to each other in such a manner as to be separable afterward.

In particular, the outer package can 10 as a welded can is a can (a so-called crimpless can) different from a crimped can which is formed by means of crimping processing. A reason for employing the crimpless can is that this increases a device space volume inside the outer package can 10, and accordingly increases an energy density per unit volume. The “device space volume” refers to a volume (an effective volume) of an internal space of the outer package can 10 available for containing therein the battery device 40 which is to be involved in charging and discharging reactions.

Here, the outer package can 10 (the container part 11 and the cover part 12) is electrically conductive, and is electrically coupled to the battery device 40 (the negative electrode 42). More specifically, the outer package can 10 is coupled to the negative electrode 42 via the negative electrode lead 52. The outer package can 10 thus serves as an external coupling terminal for the negative electrode 42. A reason for employing such a configuration is that this makes it unnecessary for the secondary battery to be provided with an external coupling terminal for the negative electrode 42 separate from the outer package can 10, and thus suppresses a decrease in device space volume resulting from providing the external coupling terminal for the negative electrode 42. As a result, the device space volume increases, and accordingly, the energy density per unit volume increases.

Specifically, the outer package can 10 (the container part 11 and the cover part 12) includes one or more of electrically conductive materials including, without limitation, a metal material and an alloy material. Examples of the electrically conductive materials include iron, copper, nickel, stainless steel, an iron alloy, a copper alloy, and a nickel alloy. Although the stainless steel is not particularly limited in kind, specific examples of the stainless steel include SUS304 and SUS316. Note that the container part 11 and the cover part 12 may include the same material, or may include respective different materials.

As will be described later, the outer package can 10 (the cover part 12) is insulated, via the gasket 30, from the external terminal 20 which serves as an external coupling terminal for the positive electrode 41. A reason for this is that this suppresses contact between the outer package can 10 (the external coupling terminal for the negative electrode 42) and the external terminal 20 (the external coupling terminal for the positive electrode 41).

As illustrated in FIGS. 1 and 2, the external terminal 20 is an electrode terminal to be coupled to electronic equipment in a case where the secondary battery is mounted on the electronic equipment. As described above, the external terminal 20 is attached to the outer package can 10, and is more specifically attached to the cover part 12. The external terminal 20 is thus supported by the cover part 12, and is insulated from the cover part 12 via the gasket 30.

Here, the external terminal 20 is electrically conductive, and is electrically coupled to the battery device 40 (the positive electrode 41). More specifically, the external terminal 20 is coupled to the positive electrode 41 via the positive electrode lead 51. The external terminal 20 thus serves as the external coupling terminal for the positive electrode 41. Accordingly, upon use of the secondary battery, the secondary battery is coupled to electronic equipment via the external terminal 20 (the external coupling terminal for the positive electrode 41) and the outer package can 10 (the external coupling terminal for the negative electrode 42). This allows the electronic equipment to operate with use of the secondary battery as a power source.

In addition, the external terminal 20 is disposed inside the bent part 12H with the gasket 30 interposed therebetween. The external terminal 20 is thus insulated from the cover part 12 via the gasket 30 as described above. Here, the external terminal 20 does not protrude above the cover part 12 (the bent part 12H). A reason for this is that this reduces the height H of the secondary battery and therefore increases the energy density per unit volume as compared with a case where the external terminal 20 protrudes above the cover part 12.

However, a portion of the external terminal 20 may protrude above the cover part 12. A reason for this is that this allows for easier coupling of the secondary battery to the electronic equipment via the external terminal 20.

Note that the external terminal 20 has an outer diameter smaller than an inner diameter of the bent part 12H. Thus, the external terminal 20 is separated from the cover part 12 surrounding the external terminal 20. Accordingly, the gasket 30 is disposed only in a portion of a region between the external terminal 20 and the cover part 12 inside the bent part 12H. More specifically, the gasket 30 is disposed only at a location where the external terminal 20 and the cover part 12 would be in contact with each other if it were not for the gasket 30.

In particular, the external terminal 20 is disposed in the through hole 12K provided in the cover part 12. The external terminal 20 is thus exposed in part outside the outer package can 10 and exposed in part inside the outer package can 10. A reason for this is that this allows for coupling of the external terminal 20 to the electronic equipment and also allows for coupling of the external terminal 20 to the battery device 40 (the positive electrode 41). Note that the external terminal 20 is insulated from the cover part 12 via the gasket 30, as described above.

A configuration (a three-dimensional shape) of the external terminal 20 is not particularly limited. Here, the external terminal 20 includes terminal parts 20A, 20B, and 20C.

The terminal part 20A is a first terminal part that is disposed in the through hole 12K. The terminal part 20A has a substantially cylindrical three-dimensional shape. The terminal part 20A has an outer diameter smaller than an inner diameter of the through hole 12K. This is to allow the gasket 30 to be interposed between the external terminal 20 (the terminal part 20A) and the cover part 12.

The terminal part 20B is a second terminal part that is disposed inside the outer package can 10 and is coupled to a lower end part of the terminal part 20A. The terminal part 20B has a substantially cylindrical three-dimensional shape. The terminal part 20B has an outer diameter greater than the outer diameter of the terminal part 20A. A reason for this is that such a difference in the outer diameter between the terminal part 20A and the terminal part 20B is usable to prevent the external terminal 20 from easily falling off from the cover part 12. Another reason is that this allows the external terminal 20 to be pressed easily toward the outside through the use of the terminal part 20B having the greater outer diameter upon an increase in the internal pressure. Note that a portion or all of the terminal part 20B may be disposed inside a winding center space 40K which will be described later.

The terminal part 20C is a third terminal part that is disposed outside the outer package can 10 and is coupled to an upper end part of the terminal part 20A. The terminal part 20C has a substantially cylindrical three-dimensional shape. The terminal part 20C has an outer diameter greater than the outer diameter of the terminal part 20A. A reason for this is that such a difference in the outer diameter between the terminal part 20A and the terminal part 20C is usable to prevent the external terminal 20 from easily falling off from the cover part 12. Another reason is that this allows the secondary battery to be easily coupled to the electronic equipment through the use of the terminal part 20C having the greater outer diameter.

A relationship between the outer diameter of the terminal part 20B and the outer diameter of the terminal part 20C is not particularly limited. Here, the outer diameter of the terminal part 20C is greater than the outer diameter of the terminal part 20B. A reason for this is that this increases an area by which the terminal part 20C is exposed, and thus allows the secondary battery to be easily coupled to the electronic equipment via the external terminal 20 (the terminal part 20C). However, the outer diameter of the terminal part 20C may be the same as or smaller than the outer diameter of the terminal part 20B.

The external terminal 20 includes one or more of electrically conductive materials including, without limitation, a metal material and an alloy material. Examples of the electrically conductive materials include aluminum and an aluminum alloy.

The gasket 30 is an insulating member disposed between the outer package can 10 (the cover part 12) and the external terminal 20, as illustrated in FIG. 2. The external terminal 20 is fixed to the cover part 12 via the gasket 30. Here, the gasket 30 is ring-shaped in a plan view, and has a through hole at a location corresponding to the through hole 12K. The gasket 30 includes one or more of insulating materials including, without limitation, a polymer compound having an insulating property. Examples of the insulating materials include polypropylene and polyethylene.

A range of placement of the gasket 30 is not particularly limited, and may be chosen as desired. Here, the gasket 30 is disposed between an upper surface of the cover part 12 and a lower surface of the external terminal 20 inside the bent part 12H, as described above.

The battery device 40 is a power generation device that causes charging and discharging reactions to proceed. As illustrated in FIGS. 1 to 4, the battery device 40 is contained inside the outer package can 10. The battery device 40 includes the positive electrode 41 and the negative electrode 42. Here, the battery device 40 further includes a separator 43 and an electrolytic solution which is a liquid electrolyte. The electrolytic solution is not illustrated.

For example, the battery device 40 is a so-called wound electrode body. That is, in the battery device 40, the positive electrode 41 and the negative electrode 42 are stacked on each other with the separator 43 interposed therebetween, and the stack of the positive electrode 41, the negative electrode 42, and the separator 43 is wound. The positive electrode 41 and the negative electrode 42 are opposed to each other and are wound. As a result, the battery device 40 has the winding center space 40K having a cylindrical shape at a center around which the positive electrode 41 and the negative electrode 42 are each wound.

Here, the positive electrode 41, the negative electrode 42, and the separator 43 are wound in such a manner that the separator 43 is disposed in each of an outermost wind and an innermost wind. Respective numbers of winds of the positive electrode 41, the negative electrode 42, and the separator 43 are not particularly limited, and may be chosen as desired.

The battery device 40 has a three-dimensional shape similar to that of the outer package can 10, that is, a flat and cylindrical three-dimensional shape. A reason for this is that this helps to prevent a so-called dead space (a surplus space between the outer package can 10 and the battery device 40) from resulting when the battery device 40 is placed inside the outer package can 10, and to thereby allow for efficient use of the internal space of the outer package can 10, as compared with a case where the battery device 40 has a three-dimensional shape different from that of the outer package can 10. As a result, the device space volume increases, and accordingly, the energy density per unit volume increases.

The positive electrode 41 is a first electrode to be used to cause the charging and discharging reactions to proceed. As illustrated in FIG. 4, the positive electrode 41 includes a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

Here, the positive electrode active material layer 41B is provided on each of the two opposed surfaces of the positive electrode current collector 41A. The positive electrode active material layer 41B includes one or more of positive electrode active materials into which lithium is insertable and from which lithium is extractable. Note that the positive electrode active material layer 41B may be provided only on one of the two opposed surfaces of the positive electrode current collector 41A, on a side where the positive electrode 41 is opposed to the negative electrode 42. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. A reason for this is that a high energy density is obtainable. Note that the lithium compound may further include one or more of other elements (elements other than lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 42 is a second electrode to be used to cause the charging and discharging reactions to proceed. As illustrated in FIG. 4, the negative electrode 42 includes a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

Here, the negative electrode active material layer 42B is provided on each of the two opposed surfaces of the negative electrode current collector 42A. The negative electrode active material layer 42B includes one or more of negative electrode active materials into which lithium is insertable and from which lithium is extractable. Note that the negative electrode active material layer 42B may be provided only on one of the two opposed surfaces of the negative electrode current collector 42A, on a side where the negative electrode 42 is opposed to the positive electrode 41. The negative electrode active material layer 42B may further include other materials including, without limitation, a negative electrode binder and a negative electrode conductor. Details of the negative electrode binder are similar to those of the positive electrode binder. Details of the negative electrode conductor are similar to those of the positive electrode conductor. A method of forming the negative electrode active material layer 42B is not particularly limited, and specifically includes one or more of methods including, without limitation, a coating method, a vapor-phase method, a liquid-phase method, a thermal spraying method, and a firing (sintering) method.

The negative electrode active material includes a carbon material, a metal-based material, or both. A reason for this is that a high energy density is obtainable. Examples of the carbon material include graphitizable carbon, non-graphitizable carbon, and graphite (natural graphite and artificial graphite). The metal-based material is a material that includes, as one or more constituent elements, one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0 < x ≤ 2 or 0.2 < x < 1.4).

Here, the negative electrode 42 has a height greater than a height of the positive electrode 41. In this case, the negative electrode 42 protrudes upward relative to the positive electrode 41, and protrudes downward relative to the positive electrode 41. A reason for this is that this suppresses precipitation of lithium extracted from the positive electrode 41. The “height” is a dimension corresponding to the height H of the secondary battery described above, that is, a dimension in an upper-lower direction in each of FIGS. 1 and 2. The definition of the height described here applies also to the following.

The separator 43 is an insulating porous film interposed between the positive electrode 41 and the negative electrode 42 as illustrated in FIGS. 2 and 4. The separator 43 allows lithium ions to pass therethrough while suppressing a short circuit between the positive electrode 41 and the negative electrode 42. The separator 43 includes a polymer compound such as polyethylene.

Here, the separator 43 has a height greater than the height of the negative electrode 42. In this case, the separator 43 protrudes upward relative to the negative electrode 42, and protrudes downward relative to the negative electrode 42. The positive electrode lead 51 is thus insulated from the battery device 40 (the negative electrode 42) via the separator 43.

The electrolytic solution includes a solvent and an electrolyte salt. The positive electrode 41, the negative electrode 42, and the separator 43 are each impregnated with the electrolytic solution. The solvent includes one or more of non-aqueous solvents (organic solvents) including, without limitation, a carbonic-acid-ester-based compound, a carboxylic-acid-ester-based compound, and a lactone-based compound. An electrolytic solution including any of the non-aqueous solvents is a so-called non-aqueous electrolytic solution. The electrolyte salt includes one or more of light metal salts including, without limitation, a lithium salt.

As illustrated in FIG. 2, the positive electrode lead 51 is contained inside the outer package can 10 and is coupled to each of the positive electrode 41 and the external terminal 20. More specifically, the positive electrode lead 51 is coupled to the positive electrode current collector 41A and is coupled to the terminal part 20B.

Here, the secondary battery includes one positive electrode lead 51. However, the secondary battery may include two or more positive electrode leads 51. A reason for this is that this decreases electric resistance of the battery device 40.

Although not particularly limited, a method of coupling the positive electrode lead 51 is specifically a welding method. Although not particularly limited in kind, the welding method specifically includes one or more of methods including, without limitation, a resistance welding method and a laser welding method. The details of the welding methods described here apply also to the following.

Details of a material included in the positive electrode lead 51 are similar to the details of the material included in the positive electrode current collector 41A. Note that the material included in the positive electrode lead 51 and the material included in the positive electrode current collector 41A may be the same as or different from each other.

A position of coupling of the positive electrode lead 51 to the positive electrode 41 (the positive electrode current collector 41A) is not particularly limited. That is, the positive electrode lead 51 may be coupled to the positive electrode 41 in the outermost wind, in the innermost wind, or in the middle of the winding between the outermost wind and the innermost wind. FIG. 2 illustrates a case where the positive electrode lead 51 is coupled to the positive electrode 41 in the middle of the winding.

Note that the positive electrode lead 51 is physically separate from the positive electrode current collector 41A and is thus provided separately from the positive electrode current collector 41A. However, the positive electrode lead 51 may be physically continuous with the positive electrode current collector 41A and may thus be provided integrally with the positive electrode current collector 41A.

As illustrated in FIG. 2, the negative electrode lead 52 is contained inside the outer package can 10 and is coupled to each of the negative electrode 42 and the outer package can 10. More specifically, the negative electrode lead 52 is coupled to the negative electrode current collector 42A and is coupled to the lower bottom part M2. Note that the negative electrode lead 52 may be coupled to the upper bottom part M1 or the sidewall part M3.

Here, the secondary battery includes one negative electrode lead 52. However, the secondary battery may include two or more negative electrode leads 52. A reason for this is that this decreases electric resistance of the battery device 40.

Details of a material included in the negative electrode lead 52 are similar to the details of the material included in the negative electrode current collector 42A. Note that the material included in the negative electrode lead 52 and the material included in the negative electrode current collector 42A may be the same as or different from each other.

A position of coupling of the negative electrode lead 52 to the negative electrode 42 (the negative electrode current collector 42A) is not particularly limited. That is, the negative electrode lead 52 may be coupled to the negative electrode 42 in the outermost wind, in the innermost wind, or in the middle of the winding between the outermost wind and the innermost wind. FIG. 2 illustrates a case where the negative electrode lead 52 is coupled to the negative electrode 42 in the outermost wind.

Note that the negative electrode lead 52 is physically separate from the negative electrode current collector 42A and is thus provided separately from the negative electrode current collector 42A. However, the negative electrode lead 52 may be physically continuous with the negative electrode current collector 42A and may thus be provided integrally with the negative electrode current collector 42A.

The sealant 60 covers the periphery of the positive electrode lead 51 in part, as illustrated in FIG. 2. The sealant 60 includes one or more of insulating materials including, without limitation, a polymer compound having an insulating property. Examples of the insulating materials include polyimide. The positive electrode lead 51 is thus insulated, via the sealant 60, from each of the outer package can 10 (the container part 11 and the cover part 12) and the battery device 40 (the negative electrode 42).

Note that the sealant 60 may be omitted if the positive electrode lead 51 is separated (insulated) from each of the outer package can 10 and the battery device 40.

Note that the secondary battery may further include one or more of other unillustrated components.

For example, the secondary battery includes a safety valve mechanism. The safety valve mechanism is a mechanism that cuts off electrical coupling between the outer package can 10 and the battery device 40 (the negative electrode 42) if an internal pressure of the outer package can 10 reaches a certain level or higher. Specific examples of a factor that causes the internal pressure of the outer package can 10 to reach the certain level or higher include a case where a short circuit occurs inside the secondary battery and a case where the secondary battery is heated from outside. A placement location of the safety valve mechanism is not particularly limited. In particular, the placement location of the safety valve mechanism is preferably a location on either the upper bottom part M1 or the lower bottom part M2, and is more preferably a location on the lower bottom part M2 to which no external terminal 20 is provided.

Further, the secondary battery includes an insulating film. The insulating film is ring-shaped in a plan view, and has a through hole at a location corresponding to the through hole 12K. Details of a material included in the insulating film are similar to the details of the material included in the sealant 60. Note that the material included in the sealant 60 and the material included in the insulating film may be the same as or different from each other.

For example, the insulating film is disposed between the positive electrode lead 51 and the battery device 40, that is, between the sealant 60 and the battery device 40, and thus suppresses contact between the positive electrode lead 51 and the negative electrode 42. The insulating film is also disposed between the outer package can 10 (the cover part 12) and the positive electrode lead 51, that is, between the cover part 12 and the sealant 60, and thus suppresses contact between the cover part 12 and the positive electrode lead 51. The insulating film is also disposed between the battery device 40 and the outer package can 10 (the lower bottom part M2), and thus suppresses contact between the positive electrode 41 and the lower bottom part M2.

Note that the outer package can 10 is provided with a cleavage valve. The cleavage valve cleaves to release the internal pressure of the outer package can 10 in a case where the internal pressure reaches a certain level or higher. A placement location of the cleavage valve is not particularly limited. In particular, as with the placement location of the safety valve mechanism described above, the placement location of the cleavage valve is preferably a location on either the upper bottom part M1 or the lower bottom part M2, and is more preferably a location on the lower bottom part M2.

To describe an operation of the secondary battery, FIG. 5 illustrates a sectional configuration corresponding to that illustrated in FIG. 2.

Upon charging of the secondary battery, in the battery device 40, lithium is extracted from the positive electrode 41, and the extracted lithium is inserted into the negative electrode 42 via the electrolytic solution. Upon discharging of the secondary battery, in the battery device 40, lithium is extracted from the negative electrode 42, and the extracted lithium is inserted into the positive electrode 41 via the electrolytic solution. Upon the charging and the discharging, lithium is inserted and extracted in an ionic state.

In this case, if a gas G is generated inside the outer package can 10 and such generation of the gas G increases the internal pressure, the pressing force caused by such an increase in the internal pressure causes the cover part 12 to be pressed toward the outside. If the pressing force exceeds the physical strength of the cover part 12 at the cleavage recess 12M, the cover part 12 thus cleaves through the use of the cleavage recess 12M, as illustrated in FIG. 5, and opens in part. This discharges the gas G to the outside of the outer package can 10, and accordingly releases the internal pressure.

In a case where the cover part 12 cleaves through the use of the cleavage recess 12M, the cover part 12 may cleave at a portion of the cleavage recess 12M to open in part. In other words, a portion (a portion on the inner side relative to the cleavage recess 12M) of the cover part 12 may be partially coupled to another portion (a portion on the outer side of the cleavage recess 12M) of the cover part 12 without being completely separated from the other portion. In this case also, the gas G is discharged, and accordingly, the internal pressure is released.

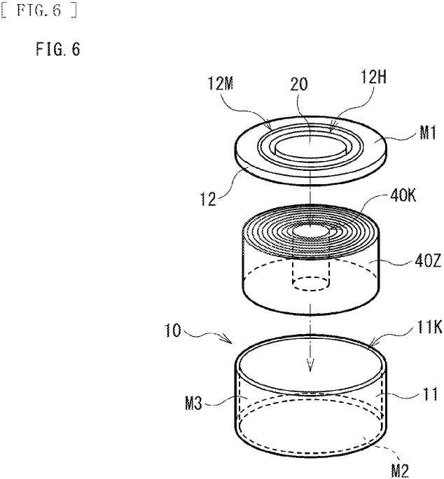

FIG. 6 illustrates a perspective configuration of the outer package can 10 to be used in a process of manufacturing the secondary battery, and corresponds to FIG. 1. Note that FIG. 6 illustrates a state where the cover part 12 is yet to be welded to the container part 11 and is thus separate from the container part 11.

In the following description, FIGS. 1 to 4 described already will be referred to in conjunction with FIG. 6.

Here, as illustrated in FIG. 6, the container part 11 and the cover part 12 that are physically separate from each other are used to form the outer package can 10. The container part 11 is a container-shaped member in which the lower bottom part M2 and the sidewall part M3 are integrated with each other, and has an opening 11K. The cover part 12 is a plate-shaped member corresponding to the upper bottom part M1, and has the cleavage recess 12M. The external terminal 20 is disposed in advance in the through hole 12K provided in the cover part 12 (the bent part 12H), and is thus fixed to the cover part 12 via the gasket 30.

However, the lower bottom part M2 and the sidewall part M3 may be separate from each other, and the container part 11 may thus be formed by welding the lower bottom part M2 to the sidewall part M3.

A mixture (a positive electrode mixture) including, for example, the positive electrode active material, the positive electrode binder, and the positive electrode conductor is put into a solvent such as an organic solvent, to thereby prepare a positive electrode mixture slurry in a paste form. Thereafter, the positive electrode mixture slurry is applied on the two opposed surfaces of the positive electrode current collector 41A to thereby form the positive electrode active material layers 41B. Thereafter, the positive electrode active material layers 41B may be compression-molded by means of, for example, a roll pressing machine. In this case, the positive electrode active material layers 41B may be heated. The positive electrode active material layers 41B may be compression-molded multiple times. In this manner, the positive electrode 41 is fabricated.

The negative electrode 42 is fabricated in accordance with a procedure similar to the procedure of fabricating the positive electrode 41. Specifically, a mixture (a negative electrode mixture) including, for example, the negative electrode active material, the negative electrode binder, and the negative electrode conductor is put into a solvent such as an organic solvent, to thereby prepare a negative electrode mixture slurry in a paste form. Thereafter, the negative electrode mixture slurry is applied on the two opposed surfaces of the negative electrode current collector 42A to thereby form the negative electrode active material layers 42B. Thereafter, the negative electrode active material layers 42B may be compression-molded. In this manner, the negative electrode 42 is fabricated.

The electrolyte salt is put into the solvent. The electrolyte salt is thereby dispersed or dissolved in the solvent. Thus, the electrolytic solution is prepared.

First, by means of a welding method, the positive electrode lead 51 covered at the periphery thereof in part by the sealant 60 is coupled to the positive electrode 41 (the positive electrode current collector 41A), and the negative electrode lead 52 is coupled to the negative electrode 42 (the negative electrode current collector 42A).

Thereafter, the positive electrode 41 with the positive electrode lead 51 coupled thereto and the negative electrode 42 with the negative electrode lead 52 coupled thereto are stacked on each other with the separator 43 interposed therebetween, following which the stack of the positive electrode 41, the negative electrode 42, and the separator 43 is wound to thereby fabricate a wound body 40Z, as illustrated in FIG. 6. The wound body 40Z has a configuration similar to that of the battery device 40 except that the positive electrode 41, the negative electrode 42, and the separator 43 are each unimpregnated with the electrolytic solution. Note that FIG. 6 omits the illustration of each of the positive electrode lead 51 and the negative electrode lead 52 to simplify contents of illustration.

Thereafter, the wound body 40Z with the positive electrode lead 51 and the negative electrode lead 52 each coupled thereto is placed into the container part 11 through the opening 11K. In this case, the negative electrode lead 52 is coupled to the container part 11 (the lower bottom part M2) by means of a welding method.

Thereafter, the electrolytic solution is injected into the container part 11 through the opening 11K. The wound body 40Z (the positive electrode 41, the negative electrode 42, and the separator 43) is thereby impregnated with the electrolytic solution. Thus, the battery device 40 which is the wound electrode body is fabricated.

Lastly, the cover part 12 is welded to the container part 11 at the opening 11K by means of a welding method. In this case, the positive electrode lead 51 is coupled to the external terminal 20 (the terminal part 20B) by means of a welding method. In this manner, the outer package can 10 is formed, and the components including, without limitation, the battery device 40 are sealed in the outer package can 10. The secondary battery is thus assembled.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery into an electrochemically stable state. The secondary battery is thus completed.

According to the secondary battery, the external terminal 20 is supported by the cover part 12 of the outer package can 10, the external terminal 20 is insulated from the cover part 12, and the cover part 12 has the cleavage recess 12M around the external terminal 20.

In this case, the cover part 12 is provided with the cleavage recess 12M. The thickness of the cover part 12 is smaller in part at the location where the cleavage recess 12M is provided, and the physical strength of the cover part 12 is lowered in part at such a location. Accordingly, if the internal pressure increases, the pressing force generated upon such an increase in the internal pressure causes the cover part 12 to be pressed toward the outside. This allows the cover part 12 to cleave easily through the use of the cleavage recess 12M.

In addition, the cleavage recess 12M is provided around the external terminal 20. Accordingly, if the internal pressure increases, the above-described pressing force causes the external terminal 20 to be pressed toward the outside. Therefore, in a region on the inner side relative to the cleavage recess 12M, the cover part 12 is greatly pressed together with the external terminal 20 toward the outside. That is, the external terminal 20 presses the cover part 12 toward the outside in response to the pressing force, and thus serves to deform the cover part 12 locally in the region on the inner side relative to the cleavage recess 12M. This allows the cover part 12 to be distorted easily around the external terminal 20, and thus allows the cover part 12 to cleave more easily through the use of the cleavage recess 12M.

For the foregoing reasons, it is possible to allow the cover part 12 to cleave easily through the use of the cleavage recess 12M upon an increase in the internal pressure, and thus allow the cover part 12 to open easily and stably when necessary. Accordingly, the gas G is discharged at the location where the cover part 12 has opened, which allows for easier releasing of the internal pressure. This helps to prevent the secondary battery from being damaged easily even if the internal pressure increases. Accordingly, it is possible to achieve superior safety.

The secondary battery also achieves the following series of advantages in particular.

Firstly, the cover part 12 is provided with both the external terminal 20 and the cleavage recess 12M. That is, the cleavage recess 12M is provided in the cover part 12 that is pressed greatly together with the external terminal 20 toward the outside due to the pressing force. The cover part 12 thus opens in a direction of the pressing force. Therefore, the direction of the pressing force (a direction in which the external terminal 20 and the cover part 12 are pressed together) and an opening direction of the cover part 12 (a releasing direction of the internal pressure) match each other. The releasing direction of the internal pressure (a discharging direction of the gas G) is therefore controlled in accordance with the respective positions at which the external terminal 20 and the cleavage recess 12M are provided. This makes it possible to control the releasing direction of the internal pressure into a desired direction. It is therefore possible to achieve superior safety also in terms thereof.

More specifically, in a case where the secondary battery is mounted on wearable electronic equipment to be worn on a human body, setting the releasing direction of the internal pressure to be different from a direction toward the human body helps to prevent a scattered material from reaching the human body when the internal pressure is released. Examples of the wearable electronic equipment include earphones, watches, and medical sensor patches. The scattered material is, for example, a component part, a damaged material, and any other material that are scattered when the secondary battery ruptures due to an increase in the internal pressure. A user of the wearable electronic equipment is thus prevented from being injured easily when the secondary battery is damaged due to an increase in the internal pressure. It is therefore possible to achieve superior safety not only in terms of suppressing the damage of the secondary battery but also in terms of suppressing injury of the user when the secondary battery is damaged.

It goes without saying that setting the releasing direction of the internal pressure to be opposite from the direction toward the human body helps to further prevent the scattered material from reaching the human body. It is therefore possible to further improve safety.

Secondly, upon an increase in the internal pressure, the cover part 12 cleaves through the use of the cleavage recess 12M, and this makes it unnecessary for the cover part 12 to slide to release the internal pressure, unlike in the secondary battery of the button type disclosed in PTL2 (U.S. Pat. No. 9178251) described above. It is therefore unnecessary to secure a space for the cover part 12 to slide in the electronic equipment on which the secondary battery is mounted, which allows the space for mounting the secondary battery in the electronic equipment to be small. It is therefore possible to achieve superior safety while achieving reduction in size of the electronic equipment on which the secondary battery is mounted.

Thirdly, a small-sized secondary battery having a small outer diameter D is small in internal volume (capacity), and therefore tends to easily undergo a sudden increase in the internal pressure. However, even if the capacity of the secondary battery is small, the cover part 12 swiftly cleaves through the use of the cleavage recess 12M in response to the increase in the internal pressure, which swiftly releases the internal pressure. It is therefore possible to secure superior safety also in the small-sized secondary battery having the small outer diameter D.

In addition, the cleavage recess 12M may be provided continuously around the external terminal 20. This allows the cover part 12 to cleave more easily through the use of the cleavage recess 12M. Accordingly, it is possible to achieve higher effects.

Further, the cover part 12 (the upper bottom part M1) may have the thickness smaller than the thickness of the container part 11 (the lower bottom part M2). This allows the cover part 12 to cleave more easily through the use of the cleavage recess 12M. Accordingly, it is possible to achieve higher effects. In this case, the thickness of the cover part 12 may be smaller than the thickness of the container part 11 (the sidewall part M3). This allows the cover part 12 to cleave further more easily through the use of the cleavage recess 12M. Accordingly, it is possible to achieve further higher effects.

Further, the cover part 12 may include the bent part 12H. This allows the cover part 12 to be pressed more easily toward the outside upon an increase in the internal pressure, and also allows the cover part 12 to be distorted more easily through the use of the difference in the pressing force between the outer side and the inner side of the bent part 12H. This allows the cover part 12 to cleave more easily through the use of the cleavage recess 12M. Accordingly, it is possible to achieve higher effects.

In this case, the external terminal 20 (the terminal part 20C) may be disposed inside the bent part 12H. This reduces the height H of the secondary battery, and accordingly increases the energy density per unit volume. It is therefore possible to achieve superior safety while securing the battery capacity. Accordingly, it is possible to achieve higher effects.

Further, the external terminal 20 may be disposed in the through hole 12K provided in the cover part 12, and the external terminal 20 may include the terminal part 20A having the smaller outer diameter and the terminal part 20B and the terminal part 20C having the respective greater outer diameters. This allows the external terminal 20 to be pressed easily toward the outside through the use of the terminal part 20B having the greater outer diameter upon an increase in the internal pressure, and allows the secondary battery to be coupled easily to the electronic equipment through the use of the terminal part 20C having the greater outer diameter. It is therefore possible to achieve superior safety while securing easiness in coupling the secondary battery to the electronic equipment. Accordingly, it is possible to achieve higher effects.

Further, the outer package can 10 may include the container part 11 and the cover part 12, and the cover part 12 may be welded to the container part 11. This increases the device space volume inside the outer package can 10, and accordingly increases the energy density per unit volume. It is therefore possible to achieve superior safety while securing the battery capacity. Accordingly, it is possible to achieve higher effects.

Further, the positive electrode 41 may be electrically coupled to the external terminal 20, and the negative electrode 42 may be electrically coupled to the outer package can 10. This allows the outer package can 10 to serve as the external coupling terminal for the negative electrode 42, and accordingly makes it unnecessary for the secondary battery to be provided with an external coupling terminal for the negative electrode 42 separate from the outer package can 10. This reduces the dimensions of the secondary battery, and accordingly increases the energy density per unit volume. It is therefore possible to achieve superior safety while securing the battery capacity. Accordingly, it is possible to achieve higher effects.

Further, the secondary battery may include a lithium-ion secondary battery. This makes it possible to obtain a sufficient battery capacity stably through the use of insertion and extraction of lithium. Accordingly, it is possible to achieve higher effects.

The configuration of the secondary battery is appropriately modifiable, as described below, according to an embodiment. Note that any two or more of the following series of modifications may be combined with each other.

In FIG. 3, the cleavage recess 12M is provided on the outer side (on the upper surface) of the cover part 12. However, although not specifically illustrated here, the cleavage recess 12M may be provided on an inner side (on the lower surface) of the cover part 12, or may be provided on both the outer side and the inner side of the cover part 12. In this case also, the cover part 12 cleaves through the use of the cleavage recess 12M. Accordingly, it is possible to achieve similar effects.

In FIG. 3, the cleavage recess 12M is provided continuously around the external terminal 20. However, the cleavage recess 12M may be provided discontinuously around the external terminal 20.

As illustrated in FIG. 7 corresponding to FIG. 3, the cover part 12 may be provided with one non-recessed part 12X, and the cleavage recess 12M may thus be provided discontinuously around the external terminal 20 with the non-recessed part 12X interposed therein (Modification 2).

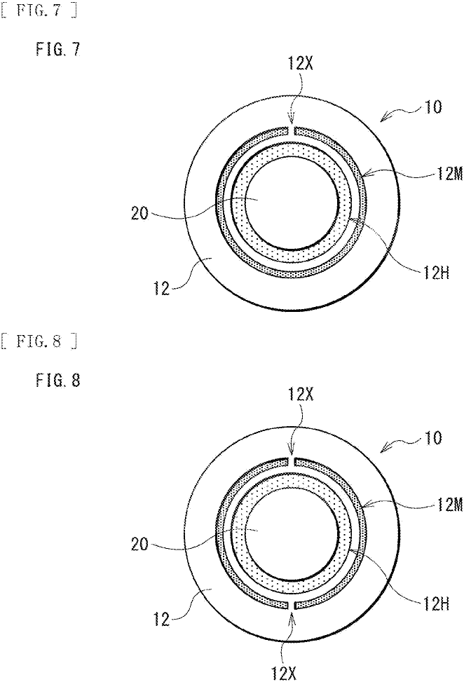

Alternatively, as illustrated in FIG. 8 corresponding to FIG. 3, the cover part 12 may be provided with two non-recessed parts 12X, and the cleavage recess 12M may thus be provided discontinuously around the external terminal 20 with the two non-recessed parts 12X interposed therein (Modification 3). A positional relationship between the two non-recessed parts 12X is not particularly limited. FIG. 8 illustrates a case where the two non-recessed parts 12X are opposed to each other with the bent part 12H interposed therebetween.

In these cases also, the cover part 12 cleaves through the use of the cleavage recess 12M. Accordingly, it is possible to achieve similar effects. In this case, the cover part 12 is prevented from cleaving at the non-recessed part 12X, which helps to prevent a cleaved portion of the cover part 12 from being separated from other portions of the cover part 12. This makes it possible to suppress, for example, falling off of the cleaved portion of the cover part 12. Note that the cover part 12 may cleave at the non-recessed part 12X depending on the magnitude of the pressing force caused by an increase in the internal pressure.

Note that a width of the non-recessed part 12X is not particularly limited, and may be chosen as desired. For example, the width of the non-recessed part 12X is within a range from 0.01 mm to 1 mm both inclusive. It goes without saying that the number of the non-recessed parts 12X is not limited to one or two, and may be three or more.

Note that in a case where the cleavage recess 12M is provided with the non-recessed part 12X, it is preferable that a range in which the cleavage recess 12M is provided continuously be sufficiently large, and is more preferable that the range in which the cleavage recess 12M is provided continuously be sufficiently large and the width of the non-recessed part 12X be sufficiently small. A reason for this is that this allows the cover part 12 to cleave stably and sufficiently through the use of the cleavage recess 12M.

In FIG. 3, the cover part 12 has one cleavage recess 12M. However, the cover part 12 may have a plurality of cleavage recesses 12M. The cleavage recesses 12M may be the same as or different from each other in width and depth.

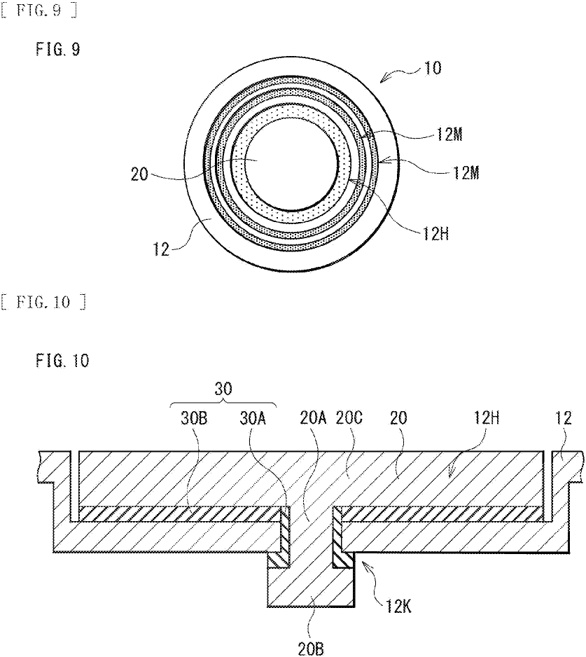

As illustrated in FIG. 9 corresponding to FIG. 3, the cover part 12 may have two cleavage recesses 12M. Here, a first cleavage recess 12M is provided on the outer side relative to the bent part 12H, and a second cleavage recess 12M is provided on an outer side relative to the first cleavage recess 12M. That is, the two cleavage recesses 12M each having the ring shape are provided concentrically about the external terminal 20 (the bent part 12H).

In this case also, the cover part 12 cleaves through the use of the cleavage recess 12M. Accordingly, it is possible to achieve similar effects. In this case, the cover part 12 cleaves more easily as compared with a case where the number of the cleavage recess 12M is only one, in particular. Accordingly, it is possible to achieve higher effects.

In FIG. 2, the gasket 30 only serves to insulate the external terminal 20 from the outer package can 10 (the cover part 12). However, the gasket 30 may also serve to release the internal pressure upon an increase in the internal pressure.

As illustrated in FIG. 10 corresponding to the FIG. 2, the gasket 30 may include two kinds of insulating parts 30A and 30B to form a discharging path for the gas G upon the increase in the internal pressure. The insulating parts 30A and 30B differ from each other in melting point. Note that FIG. 10 extracts only the vicinity of the external terminal 20 and the gasket 30 and illustrates it in an enlarged manner.

The insulating part 30A is a first insulating part disposed on the inner side of the cover part 12. More specifically, the insulating part 30A is disposed between each of the terminal parts 20A and 20B and the cover part 12. The insulating part 30A includes one or more of first polymer compounds having an insulating property. The first polymer compounds each have a sufficiently high melting point, more specifically, a melting point higher than a melting point of a second polymer compound included in the insulating part 30B to be described later.

The first polymer compound is not limited to a particular kind, and specifically includes one or more of materials including, without limitation, a copolymer of tetrafluoroethylene and perfluoroalkyl vinyl ether (PFA) and polyphenylenesulfide (PPS). A reason for this is that the materials including, without limitation, PFA each have a sufficiently high melting point (i.e., about 310° C.) and are superior in a sealing property, heat resistance, and resistance to an electrolytic solution.

The insulating part 30B is a second insulating part disposed on the outer side of the cover part 12. More specifically, the insulating part 30B is disposed between the terminal part 20C and the cover part 12. The insulating part 30B includes one or more of the second polymer compounds having an insulating property. The second polymer compounds each have a sufficiently low melting point, more specifically, a melting point that is lower than the melting point of each of the one or more first polymer compounds included in the insulating part 30A.

The second polymer compound is not limited to a particular kind, and specifically includes one or more of materials including, without limitation, polybutylene terephthalate (PBT) and polypropylene (PP). A reason for this is that the materials including, without limitation, PBT each have a melting point sufficiently lower than the melting point of any of the above-described materials including, without limitation, PFA (for example, the melting point of PBT is within a range from about 225° C. to about 267° C. both inclusive).

Here, examples of a specific combination of the first polymer compound and the second polymer compound include a combination of PFA and PBT, a combination of PPS and PBT, a combination of PFA and PP, and a combination of PPS and PP.

Note that a thickness of each of the insulating parts 30A and 30B is not particularly limited, and is specifically 300 µm or less.

A principle on the basis of which the internal pressure is released through the use of the gasket 30 (the insulating parts 30A and 30B) in the secondary battery is as described below.

In a case where the secondary battery is heated at a high temperature in a short time, that is, in a case where the secondary battery is rapidly heated by a high-temperature heat source, the battery device 40 (the electrolytic solution) reacts excessively in an abnormal way, which can result in generation of a large amount of the gas G in a short time. In a case where the internal pressure is rapidly increased thereby, there may not be enough time for the cover part 12 to cleave through the use of the cleavage recess 12M. Accordingly, the secondary battery can ignite or can be damaged before the cover part 12 cleaves through the use of the cleavage recess 12M.

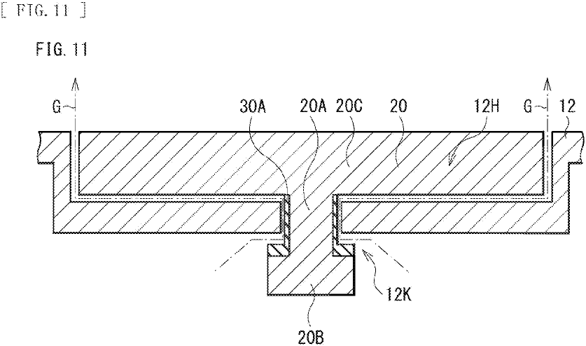

However, in the secondary battery including the gasket 30 (the insulating parts 30A and 30B), the gasket 30 exhibits a function of releasing the internal pressure as illustrated in FIG. 11 corresponding to FIG. 10 if the secondary battery is rapidly heated.

In this case, while each of the cover part 12 and the external terminal 20 is pressed toward the outside in response to the pressing force, the insulating part 30B having the melting point lower than the melting point of the insulating part 30A undergoes thermal deformation. This produces a gap between the cover part 12 and the external terminal 20 to form the discharging path for the gas G, and accordingly releases the internal pressure. In a case where there is not enough time for releasing the internal pressure (discharging the gas G) as described above because of the rapid heating of the secondary battery, and in a case where the gas G is generated in a temperature range that does not cause the thermal deformation of the insulating part 30B to occur, the cover part 12 deforms and the external terminal 20 presses the cover part 12 upward, which allows the cover part 12 to cleave through the use of the cleavage recess 12M. The internal pressure (the gas G) is thus released before the secondary battery ruptures.

Accordingly, in the case where the gasket 30 (the insulating parts 30A and 30B) is provided, the internal pressure (the gas G) is released also in a case where the secondary battery is rapidly heated or in any other case. This allows for further easier releasing of the internal pressure, making it possible to achieve further superior safety.

In FIG. 2, the positive electrode 41 (the first electrode) is electrically coupled to the external terminal 20, and the negative electrode 42 (the second electrode) is electrically coupled to the outer package can 10. Thus, the external terminal 20 serves as the external coupling terminal for the positive electrode 41, and the outer package can 10 serves as the external coupling terminal for the negative electrode 42.

However, although not specifically illustrated here, the positive electrode 41 (the second electrode) may be electrically coupled to the outer package can 10, and the negative electrode 42 (the first electrode) may be electrically coupled to the external terminal 20. Thus, the outer package can 10 may serve as the external coupling terminal for the positive electrode 41, and the external terminal 20 may serve as the external coupling terminal for the negative electrode 42.

To serve as the external coupling terminal for the negative electrode 42, the external terminal 20 includes one or more of electrically conductive materials including, without limitation, a metal material and an alloy material. Examples of the electrically conductive materials include iron, copper, nickel, stainless steel, an iron alloy, a copper alloy, and a nickel alloy. To serve as the external coupling terminal for the positive electrode 41, the outer package can 10 includes one or more of electrically conductive materials including, without limitation, a metal material and an alloy material. Examples of the electrically conductive materials include aluminum, an aluminum alloy, and stainless steel.

In this case also, the secondary battery is couplable to electronic equipment via the external terminal 20 (the external coupling terminal for the negative electrode 42) and the outer package can 10 (the external coupling terminal for the positive electrode 41). Accordingly, it is possible to achieve similar effects.

Although the present technology has been described above with reference to one or more embodiments, the configuration of the present technology is not limited thereto, and is therefore modifiable in a variety of ways.

Although the description has been given of the case where the outer package can is the welded can (the crimpless can), the outer package can is not particularly limited to in configuration. Accordingly, the outer package can may be a crimped can having undergone crimping processing. In the crimped can, the container part and the cover part that are separate from each other are crimped to each other with the gasket interposed therebetween.

Further, although the description has been given of the case where the battery device has a device structure of a wound type, the device structure of the battery device is not particularly limited, and may thus be of a stacked type in which the electrodes (the positive electrode and the negative electrode) are stacked, a zigzag folded type in which the electrodes are folded in a zigzag manner, or any other type.

Further, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member having a flat and columnar shape and including a first bottom part and a second bottom part opposed to each other;
an electrode terminal supported by the first bottom part and insulated from the first bottom part; and
a battery device contained inside the outer package member and including a first electrode and a second electrode, wherein
the first bottom part has a recess around the electrode terminal.

2. The secondary battery according to claim 1, wherein the recess is provided continuously or discontinuously around the electrode terminal.

3. The secondary battery according to claim 1, wherein the first bottom part has a plurality of the recesses.

4. The secondary battery according to claim 1, wherein the first bottom part has a thickness smaller than a thickness of the second bottom part.

5. The secondary battery according to claim 4, wherein
the outer package member further includes a sidewall part coupled to each of the first bottom part and the second bottom part, and
the thickness of the first bottom part is smaller than a thickness of the sidewall part.

6. The secondary battery according to claim 1, wherein the first bottom part includes a bent part resulting from the first bottom part being bent to protrude in part toward an inside of the outer package member.

7. The secondary battery according to claim 6, wherein at least a portion of the electrode terminal is disposed inside the bent part.

8. The secondary battery according to claim 1, wherein
the first bottom part has a through hole, and
the electrode terminal includes
a first terminal part disposed in the through hole,
a second terminal part disposed inside the outer package member and having an outer diameter greater than an outer diameter of the first terminal part, and
a third terminal part disposed outside the outer package member and having an outer diameter greater than the outer diameter of the first terminal part.

9. The secondary battery according to claim 8, further comprising
an insulating member disposed between the first bottom part and the electrode terminal, wherein
the insulating member includes
a first insulating part disposed between each of the first and the second terminal parts and the first bottom part and including a first polymer compound, and
a second insulating part disposed between the third terminal part and the first bottom part and including a second polymer compound that has a melting point lower than a melting point of the first polymer compound.

10. The secondary battery according to claim 9, wherein
the first polymer compound includes a copolymer of tetrafluoroethylene and perfluoroalkyl vinyl ether, polyphenylenesulfide, or both, and
the second polymer compound includes polybutylene terephthalate, polypropylene, or both.

11. The secondary battery according to claim 1, wherein
the outer package member further includes a sidewall part coupled to each of the first bottom part and the second bottom part,
the outer package member includes
a cover part corresponding to the first bottom part, and
a container part containing the battery device inside and corresponding to the second bottom part and the sidewall part, and
the cover part is welded to the container part.

12. The secondary battery according to claim 1, wherein
the first electrode is electrically coupled to the electrode terminal, and
the second electrode is electrically coupled to the outer package member.

13. The secondary battery according to claim 1, wherein the secondary battery comprises a lithium-ion secondary battery.
